(19) United States
(12) Patent Application Publication
(10) Pub. No.: US 2023/0078931 A1
(43) Pub. Date: Mar. 16, 2023

(54) NETWORK SYSTEM AND NETWORK SWITCHING METHOD

(71) Applicant: NIPPON TELEGRAPH AND TELEPHONE CORPORATION, Tokyo (JP)

(72) Inventors: Hideaki KIMURA, Musashino-shi, Tokyo (JP); Akihiro MORITA, Musashino-shi, Tokyo (JP); Yuhei KAWAKAMI, Musashino-shi, Tokyo (JP)

(73) Assignee: NIPPON TELEGRAPH AND TELEPHONE CORPORATION, Tokyo (JP)

(21) Appl. No.: 17/802,214

(22) PCT Filed: Feb. 28, 2020
(86) PCT No.: PCT/JP2020/008476

§ 371 Date: Aug. 25, 2022

(51) Int. Cl. H04L 45/00; H04L 45/42

(52) U.S. Cl. CPC H04L 45/22; H04L 45/38; H04L 45/42

(57) ABSTRACT

The present disclosure enables a user device to connect to a network via a single edge device out of a plurality of existing edge devices without information being communicated between the edge devices and a device that branches signals and provides branched signals to a plurality of edge devices.

A network system according to the present disclosure is a network system in which a plurality of edge devices each have a user acceptance port and a network-side port, the user acceptance ports are connected to a branch device connected to a user device, the network-side ports obtain information on the user acceptance ports, and based on the information on the user acceptance ports, a single edge device out of the plurality of edge devices sets its user acceptance port to be open and be capable of performing traffic transfer with the user device, and the edge devices excluding the single edge device out of the plurality of edge devices set their user acceptance ports to be closed and discard traffic from the user device.

### TECHNICAL FIELD

The present invention relates to a network system capable of switching edge devices that accept a user device.

### BACKGROUND ART

Most network systems have two or more redundant paths. This configuration, in the case in which a failure occurs in a path, or periodic maintenance is performed on a path, makes it possible to avoid a long-time communication interruption by making users using the affected path take a detour.

In addition to the redundancy of paths, making devices redundant can ensure high reliability. Use of a plurality of devices makes it possible to avoid a long-time communication interruption even in the case of a device failure.

In another view point, there is also an advantageous effect of employing a device redundant configuration in that it makes periodic maintenance on devices, replacement of devices, and doing periodic maintenance easy.

Now, think about a network as illustrated in FIG. 1. In the network system in FIG. 1, a user device 31 is connected to a network 1 via a path 411 and an edge device 21. A user device 32 is connected to the network 1 via a path 421 and an edge device 22-1, and can also be connected to the network 1 via a path 422 and an edge device 22-2.

In this configuration, the user device 31, in the case of replacing the edge device 21 or doing periodic maintenance on the edge device 21, cannot communicate with the network 1. In contrast, the user device 32, in the case of replacing the edge device 22-1 or doing periodic maintenance on the edge device 22-1, can continue communicating with the network 1 via the edge device 22-2.

As described above, use of a plurality of edge devices and a plurality of paths leading the edge device enables continuous communication even in the case of replacing or doing periodic maintenance on a device connecting between a network and a user device. However, there is an issue that this configuration requires a plurality of paths that require a plurality of ports for the user device which is the counter device of the edge devices. In particular, in the case where the distances between the edge devices and the user device are long, a plurality of long distance paths need to be prepared, increasing the cost.

A method to solve such an issue is inserting an optical switch between the edge devices and the user device (for example, see Patent Literature 1). In this case, different paths according to the edge devices need to be prepared between the optical switch and the edge devices, but the paths can be put together into a single path between the optical switch and the user device. Thus, if the optical switch is disposed very close to the edge devices, it is possible to solve the issue of preparing a plurality of long distance paths.

In the method in Patent Literature 1, when the connection destination of the user device is switched to a new edge device by the optical switch, and the edge devices are notified of the path state resulting from the switching of the optical switch. With this operation, information on the edge device to which the user device was previously connected is updated to information on the edge device to which the user device is newly connected by the switching of the optical switch, and thus, communication can be continued without affecting the user device.

In the case of using the method in Patent Literature 1, cooperation between the edge devices and the optical switch is necessary. Hence, a method is necessary for correctly communicating the states between the edge devices and the optical switch, which are totally different products, for example, an information linkage interface.

### CITATION LIST

### Patent Literature

Patent Literature 1: Japanese Patent No. 6053172

### SUMMARY OF THE INVENTION

### Technical Problem

The present invention has been made by focusing attention on the above situation, and an object thereof is to provide a network system that enables a user device to connect to a network via a single edge device out of a plurality of existing edge devices without information being communicated between the edge devices and a device that branches signals and provides branched signals to the plurality of edge devices.

### Means for Solving the Problem

The viewpoints of the present invention to achieve the above object include the constituents as follows: Specifically, a network system has a branch device between edge devices and a user device, the edge devices can communicate with one another via a network, and based on information exchange via the network, user acceptance ports of edge devices are closed.

Specifically, a network system according to the present disclosure is
a network system that enables a user device to connect to a network via a single edge device out of a plurality of edge devices, in which
the plurality of edge devices each have a user acceptance port and a network-side port,
each of the user acceptance port included in the plurality of edge devices is connected to the user device via a branch device,
each of the network-side port included in the plurality of edge devices is used to exchange information on the user acceptance port among the plurality of edge devices,
based on the exchanged information on the user acceptance port,
only a single edge device out of the plurality of edge devices sets the user acceptance port of the single edge device to be open and be capable of performing traffic transfer with the user device, and
the other edge devices of the plurality of edge devices, excluding the single edge device, set the user acceptance ports of the other edge devices to be closed and discard traffic from the user device.

Specifically, a network switching method according to the present disclosure is
a network switching method of, in a network system in which a plurality of edge devices are connected to one network, switching a single edge device that performs traffic transfer with a user device, out of the plurality of edge devices, in which
the user device is physically connected to the plurality of edge devices via a branch device,
the plurality of edge devices each include a user acceptance port connected to the branch device and a network-side port connected to the network,
each of the network-side port included in the plurality of edge devices obtains information on the user acceptance port, and
the plurality of edge devices, based on the information on the user acceptance ports,
cause only a single edge device out of the plurality of edge devices to set the user acceptance port of the single edge device to be open and be capable of performing traffic transfer with the user device,
cause the other edge devices of the plurality of edge devices, excluding the single edge device, to set the user acceptance ports of the other edge devices to be closed and discard traffic from the user device, and
thereby switch the user acceptance port to be opened and the user acceptance ports to be closed.

### Effects of the Invention

The present invention makes it possible to switch edge devices that accept a user device without having a plurality of paths leading from the user device to the edge devices.

### BRIEF DESCRIPTION OF DRAWINGS

FIG. 1 is a diagram illustrating a conventional network system in which edge device can be switched.

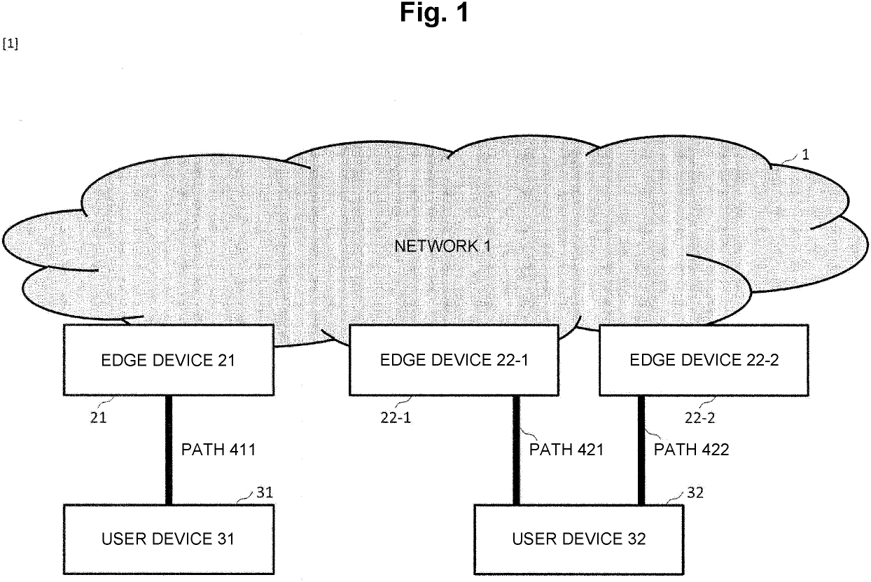

FIG. 2 is a diagram illustrating a network system in which information exchange between edge devices enables a user device to connect to a network via a single edge device out of a plurality of existing edge devices.

FIG. 3 is a diagram illustrating a network system in which information exchange between edge devices and an open-user-acceptance-port determination device enables a user device to connect to a network via a single edge device out of a plurality of existing edge devices.

### DESCRIPTION OF EMBODIMENTS

Hereinafter, network systems of embodiments according to the present invention capable of switching edge devices will be described with reference to drawings. Note that in the following embodiments, portions denoted by the same numbers are assumed to perform the same or similar operation, and repetitive description of them is omitted. Note that a network system according to the present disclosure capable of switching edge devices can be used in the information and communication industry. In the following, a communication network in which traffic communication can be performed directly or indirectly between a plurality of devices is called a network.

### First Embodiment

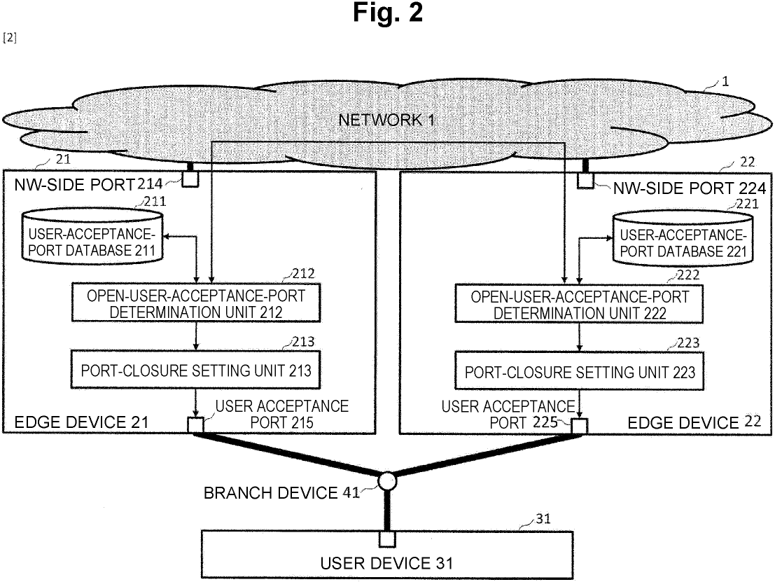

A network system in which a user device can connect to a network via a single edge device out of a plurality of existing edge devices is a network system including a network 1, a plurality of edge devices 21 to 2 n (n is an integer of 2 or more. There are two edge devices 21 and 22 in FIG. 2), a user device 31, and a branch device 41, in which
the edge device 21 includes a user-acceptance-port database 211, an open-user-acceptance-port determination unit 212, a port-closure setting unit 213, a NW (network)-side port 214, and a user acceptance port 215,
the edge device 22 includes a user-acceptance-port database 221, an open-user-acceptance-port determination unit 222, a port-closure setting unit 223, a NW-side port 224, and a user acceptance port 225,
the user device 31 has connectivity to connect to the user acceptance ports 215 and 225 of the edge devices via the branch device 41,
the edge device 21 has connectivity to connect to the edge device 22 via the NW-side port 214 and the network 1, and
the edge device 22 has connectivity to connect to the edge device 21 via the NW-side port 224 and the network 1.

The user device 31 has physical connectivity ensured so that it can connect to the plurality of edge devices 21 and 22 via the branch device 41. This network system is characterized in that the edge devices 21 and 22 exchange information and close a user acceptance port at each moment so that the single user device 31 can communicate with only one of the user acceptance ports 215 and 225 connected to the single user device 31.

The branch device 41 copies one input signal into two or more output signals. A feature here is that the formats of the input signal and the output signal are the same. Specifically, the input signal and the output signal may be a single optical input signal, or an electrical input signal may be copied into two or more optical output signals or electrical output signals. An example of a device for copying optical signals is an optical coupler, and an example of a device for copying electrical signals is an electric coupler.

The user-acceptance-port database 211 of the edge device 21 holds data on a set of user acceptance ports connected to the single user device. Specifically, in the example of FIG. 2, the user-acceptance-port database 211 holds, for example, information that the user acceptance port 215 of the edge device 21 and the user acceptance port 225 of the edge device 22 are connected to the single user device. Although in FIG. 2, two user acceptance ports are connected to the single user device 31, three or more user acceptance ports may be connected to the single user device.

The open-user-acceptance-port determination unit 212 exchanges information with another edge device, in this case, the edge device 22 having a user acceptance port connected to the same user device 31 via the branch device 41, and determines an only one user acceptance port that can communicate with the user device 31.

Specifically, the open-user-acceptance-port determination unit 212 of the edge device 21 communicates with the open-user-acceptance-port determination unit 222 of the edge device 22 and exchanges information necessary to determine which of the user acceptance port 215 of the edge device 21 and the user acceptance port 225 of the edge device 22 is to communicate with the user device 31. The information mentioned above is information used to determine an open-user acceptance port based on a single rule in all the edge devices. Although details will be described later, in the case of using, for example, a rule that unique identification information that each device has is compared, and an edge device and the user acceptance port that will communicate with the user device are determined based on the magnitude of the unique identification information, the unique identification information that each device has is exchanged between the edge devices.

To exchange the information mentioned above, the network 1 is used; specifically, the NW-side port 214 of the edge device 21, the network 1, and the NW-side port 224 of the edge device 22 are used to exchange the information. Alternatively, to exchange information on the user acceptance port, a third port other than the user acceptance port and the NW-side port may be used, for example, a port connected to a management network. For information exchange necessary to determine the open-user acceptance port, any port capable of connecting to other edge devices and other than the user acceptance port may be used.

The open-user-acceptance-port determination unit 212, based on information collected by the information exchange, determines the open-user acceptance port. All the edge devices need to determine the open-user acceptance port based on a single rule. For example, as a possible method, a unique identifier that each user acceptance port has may be used: for example, the user acceptance port having the smallest MAC address is specified as the open-user acceptance port. As another possible method, a unique identifier that each edge device has may be used in parallel: for example, the user acceptance port of an edge device having a high priority is specified as the open-user acceptance port.

The port-closure setting unit 213 performs closure control for its user acceptance port based on the result by the open-user-acceptance-port determination unit 212. Specifically, in the case in which the open-user-acceptance-port determination unit 212 determines that “the user acceptance port of the device that it belongs to is the open-user acceptance port”, the port-closure setting unit 213 makes the user acceptance port 215 open. In the case in which the open-user-acceptance-port determination unit 212 determines that “the user acceptance port of the device that it belongs to is not the open-user acceptance port”, the port-closure setting unit 213 makes the user acceptance port 215 closed.

The network system according to the first embodiment of the present invention, as described above, performs information exchange by using ports that the edge devices have other than the user acceptance ports, opens an only one user acceptance port exclusively out of the user acceptance ports connected to the same user device 31, closes the other user acceptance ports, and thus explicitly determines the edge device that the user device 31 will use.

In a case in which replacement or periodic maintenance is performed on the edge device having the open-user acceptance port, the open-user acceptance port is changed. Specifically, an open-user acceptance port may be determined out of the edge devices excluding the edge device that needs replacement or periodic maintenance, and the user acceptance port that is open may be changed. In this operation, when the open-user acceptance port is changed from the previously-set open-user acceptance port to the newly-set open-user acceptance port, the setting information on the previously-set open-user acceptance port should desirably be taken over to the newly-set open-user acceptance port at the same time. Specifically, it is necessary, for example, that the user-acceptance-port setting information is transferred, being triggered by the change of the open-user acceptance port, or that the same setting is inputted in advance to all the user acceptance ports connected to the single user device via the branch device regardless of the change of the open-user acceptance port.

The user device 31 transmits and receives traffic by using the edge device the user acceptance port of which is open, out of the plurality of edge devices to which the user device 31 is directly connected.

For connection between the edge devices and the user device, optical cable and an optical branch device may be used, or electrical cable and an electrical branch device may be used, too.

### Second Embodiment

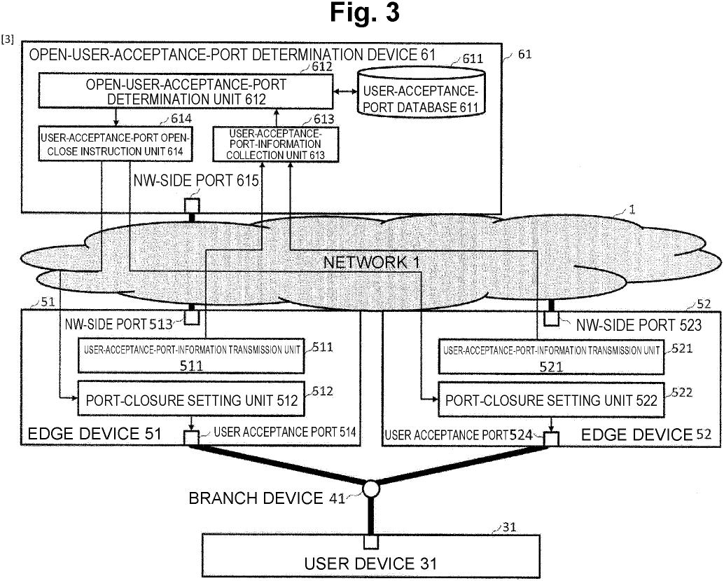

A network system in which a user device can connect to a network via a single edge device out of a plurality of existing edge devices is a network system including a network 1, a plurality of edge devices 51 to 5n (n is an integer of 2 or more. There are two edge devices 51 and 52 in FIG. 3), a user device 31, and a branch device 41, and an open-user-acceptance-port determination device 61, in which
the edge device 51 includes a user-acceptance-port-information transmission unit 511, a port-closure setting unit 512, a NW-side port 513, and a user acceptance port 514,
the edge device 52 includes a user-acceptance-port-information transmission unit 521, a port-closure setting unit 522, a NW-side port 523, and a user acceptance port 524,
the open-user-acceptance-port determination device 61 includes a user-acceptance-port database 611, an open-user-acceptance-port determination unit 612, a user-acceptance-port-information collection unit 613, a user-acceptance-port open-close instruction unit 614, and a NW-side port 615,
the user device 31 has connectivity to connect to the user acceptance ports 514 and 524 of the edge devices via the branch device 41,
the edge device 51 has connectivity to connect to the open-user-acceptance-port determination device 6 via the NW-side port 513 and the network 1, and
the edge device 52 has connectivity to connect to the open-user-acceptance-port determination device 6 via the NW-side port 523 and the network 1.

The user device 31 has physical connection such that it can connect to a plurality of edge devices 51 and 52 via the branch device 41. This network system is characterized in that the edge devices 51 and 52 exchange information via the open-user-acceptance-port determination device 61 and close a user acceptance port at each moment such that the single user device 31 can communicate with only one of the user acceptance ports 514 and 524 connected to the single user device 31.

The user-acceptance-port-information transmission units 511 and 521 of the edge devices 51 and 52 transmit information to the user-acceptance-port-information collection unit 613 of the open-user-acceptance-port determination device 61. The information mentioned above is used to determine the open-user acceptance port. Although details will be described later, in the case of using, for example, a rule that unique identification information that the edge devices 51 and 52 have are compared, and that an edge device and the user acceptance port that will communicate with the user device 31 are determined based on the magnitude of the unique identification information, the edge devices 51 and 52 transmits the unique identification information that the edge devices 51 and 52 have.

For the transmission of the information mentioned above, the network 1 is used. Specifically, to transmit information from the user-acceptance-port-information transmission unit 511 to the user-acceptance-port-information collection unit 613, the NW-side port 513 of the edge device 51, the network 1, and the NW-side port 615 of the open-user-acceptance-port determination device 61 are used. For transmission of information used to determine the open-user acceptance port, a third port other than the user acceptance port and the NW-side port may be used, for example, a port connected to a management network. For transmission of information used to determine the open-user acceptance port, any port capable of connecting the edge device 51 or 52 and the open-user-acceptance-port determination device 61 may be used.

The information transmitted from the user-acceptance-port-information transmission units 511 and 521 of the edge devices 51 and 52 are collected at the user-acceptance-port-information collection unit 613 of the open-user-acceptance-port determination device 61.

The user-acceptance-port database 611 of the open-user-acceptance-port determination device 61 holds data on a set of user acceptance ports connected to the single user device. Specifically, in the example of FIG. 3, the user-acceptance-port database 611 holds, for example, information that the user acceptance port 514 of the edge device 51 and the user acceptance port 524 of the edge device 52 are connected to the single user device 31.

The open-user-acceptance-port determination unit 612 determines the open-user acceptance port based on the information in the user-acceptance-port database 611 and the information collected by the user-acceptance-port-information collection unit 613. For example, as a possible, a unique identifier that each user acceptance port has may be used: for example, the user acceptance port having the smallest MAC address is specified as the open-user acceptance port. As another possible method, a unique identifier that each edge device has may be used in parallel: for example, the user acceptance port of an edge device having a high priority is specified as the open-user acceptance port.

Based on the result by the open-user-acceptance-port determination unit 612, user-acceptance-port closing control of each edge device is performed. Specifically, for a user acceptance port, if the open-user-acceptance-port determination unit 612 determines that “this user acceptance port is the open-user acceptance port”, the user-acceptance-port open-close instruction unit 614 instructs the port-closure setting unit not to perform closure setting. For a user acceptance port, if the open-user-acceptance-port determination unit 612 determines that “this user acceptance port is not the open-user acceptance port”, the user-acceptance-port open-close instruction unit 614 instructs the port-closure setting unit to perform closure setting. When the user-acceptance-port open-close instruction unit 614 transmits an instruction on closing or opening to the port-closure setting unit of each edge device, the transmission is performed via the network 1 or another network typified by a management network.

The network system according to the second embodiment of the present invention, as described above, performs information exchange between the edge devices 51 and 52 and the open-user-acceptance-port determination device 61, opens only one user acceptance port out of the user acceptance ports connected to the user device 31, and closes the other user acceptance ports. This operation makes it possible to explicitly determine the edge device that the user device 31 will use.

In a case in which replacement or periodic maintenance is performed on the edge device having the open-user acceptance port, the open-user acceptance port is changed. Specifically, an open-user acceptance port may be determined out of the edge devices excluding the edge device that needs replacement or periodic maintenance, and the user acceptance port that is open may be changed. In this operation, when the open-user acceptance port is changed from the previously-set open-user acceptance port to the newly-set open-user acceptance port, the setting information on the previously-set open-user acceptance port should desirably be taken over to the newly-set open-user acceptance port at the same time. Specifically, it is necessary, for example, that the user-acceptance-port setting information is transferred, being triggered by the change of the open-user acceptance port, or that the same setting is inputted in advance to all the user acceptance ports connected to the single user device via the branch device regardless of the change of the open-user acceptance port.

The user device 31 transmits and receives traffic by using the edge device the user acceptance port of which is open, out of the plurality of edge devices to which the user device 31 is directly connected.

For connection between the edge devices and the user device, optical cable and an optical branch device may be used, or electrical cable and an electrical branch device may be used, too.

Note that the present disclosure is not limited to the above embodiments. These embodiments are mere examples, and the present disclosure can be implemented as embodiments obtained by changing or improving the present disclosure in various ways based on the knowledge of those skilled in the art. The devices of the present disclosure can be built by using a computer and a program, and the program can be recorded on a recording medium or can be provided through a network.

### INDUSTRIAL APPLICABILITY

The present disclosure can be used in the information communication industry.

### REFERENCE SIGNS LIST

1 Network
21, 22, 22-1, 22-2 Edge device
31, 32 User device
41 Branch device
61 Open-user-acceptance-port determination device
411, 421, 422 Path
211, 221 User-acceptance-port database
212, 222 Open-user-acceptance-port determination unit
213, 223 port-closure setting unit
214, 224, 513, 523, 615 Network-side port
215, 225 User acceptance port
511, 521 User-acceptance-port-information transmission unit
512, 422 port-closure setting unit
611 User-acceptance-port database
612 Open-user-acceptance-port determination unit
613 User-acceptance-port-information collection unit
614 User-acceptance-port open-close instruction unit

1. A network system that enables a user device to connect to a network via a single edge device out of a plurality of edge devices, wherein
the plurality of edge devices each have a user acceptance port and a network-side port,
each of the user acceptance port included in the plurality of edge devices is connected to the user device via a branch device,
each of the network-side port included in the plurality of edge devices is used to exchange information on the user acceptance port among the plurality of edge devices,
based on the exchanged information on the user acceptance port,
only a single edge device out of the plurality of edge devices sets the user acceptance port of the single edge device to be open and be capable of performing traffic transfer with the user device, and the other edge devices of the plurality of edge devices, excluding the single edge device, set the user acceptance ports of the other edge devices to be closed and discard traffic from the user device.

2. The network system according to claim 1, wherein each of the network-side port included in the plurality of edge devices obtains, from the other edge devices out of the plurality of edge devices, information on the user acceptance ports of the other edge devices, and the plurality of edge devices
determines whether to make the user acceptance port of the edge device itself open based on the obtained information,
if the edge device determines that the user acceptance port of the edge device itself is to be open, sets the user acceptance port included in the edge device itself to be open and be capable of performing traffic transfer with the user device, and
if the edge device determines that the user acceptance port of the edge device itself is not to be open, sets the user acceptance port included in the edge device itself to be closed and discard the traffic from the user device.

3. The network system according to claim 1, comprising an open-user-acceptance-port determination device that collects information on the user acceptance ports from the plurality of edge devices and determines the single edge device the user acceptance port of which is to be opened based on the collected information, wherein
each of the network-side port included in the plurality of edge devices obtains an instruction from the open-user-acceptance-port determination device, and
the plurality of edge devices
if the instruction obtained by the network-side port is an instruction to open the user acceptance port, sets the user acceptance port included in the edge device itself to be open and be capable of performing traffic transfer with the user device, and
if the instruction obtained by the network-side port is an instruction to close the user acceptance port, sets the user acceptance port included in the edge device itself to be closed and discard traffic from the user device.

4. A network switching method of, in a network system in which a plurality of edge devices are connected to one network, switching a single edge device that performs traffic transfer with a user device, out of the plurality of edge devices, wherein
the user device is physically connected to the plurality of edge devices via a branch device,
the plurality of edge devices each include a user acceptance port connected to the branch device and a network-side port connected to the network,
each of the network-side port included in the plurality of edge devices obtains information on the user acceptance port, and
the plurality of edge devices, based on the information on the user acceptance ports,
cause only a single edge device out of the plurality of edge devices to set the user acceptance port of the single edge device to be open and be capable of performing traffic transfer with the user device,
cause the other edge devices of the plurality of edge devices, excluding the single edge device, to set the user acceptance ports of the other edge devices to be closed and discard traffic from the user device, and thereby switch the user acceptance port to be opened and the user acceptance ports to be closed.
